(19) United States
(12) Patent Application Publication
(10) Pub. No.: US 2004/0046701 A1
(43) Pub. Date: Mar. 11, 2004

(54) Radio communications device comprising an sar value-reducing correction element

(76) Inventors: Stefan Huber, Munchen (DE); Michael Schreiber, Aying-Goggenhofen (DE); Martin Weinberger, Munchen (DE); Markus Larkamp, Krefeld (DE); Ortwin Schrage, Kempen (DE)

Correspondence Address: BELL, BOYD & LLOYD, LLC, P. O. BOX 1135, CHICAGO, IL, 60690-1135, US

(21) Appl. No.: 10/471,149

(22) PCT Filed: Feb. 28, 2002
(86) PCT No.: PCT/DE02/00735

(30) Foreign Application Priority Data
Mar. 7, 2001 (DE) 101 10 982.2

(51) Int. Cl. H01Q 1/24

(52) U.S. Cl. 343/702

(57) ABSTRACT

The invention relates to a radio communications device in which at least one additional SAR value-reducing correction element (KE1) is provided in and/or on the housing (GH) in such a manner that the distribution of any electric current (EC1) which might be flowing on the printed circuit board (LP) is effected from one or more local maxima (MA) thereof up to the correction element (KE1). When using the mobile radio device (MP1), a homogenization and/or a shift thus adjusts with regard to the local distribution of the overall resulting electric current (EC1*).

The invention relates to a radio communication device with a housing and at least one printed circuit board housed therein for sending and/or receiving radio signals.

With mobile radio devices it is desirable to keep the electromagnetic radiation loading dose as low as possible for the respective user, in order to reduce any potential health risk as far as possible. One protective measure for this purpose is for example known from EP 0 603 081 A1, with which an electromagnetically absorbent screening plate is positioned between the zone of the mobile radio telephone with the highest level of radiation and the head of the respective user as a type of radiation-blocking partition in the housing of the mobile radio telephone. A further protective measure is for example the protective film with electromagnetic screening characteristics known from DE 196 08 189 A1, which only covers the antenna and part of the outer surface of the housing of a mobile radio device on the side facing the user. The screening effect of this film can be improved by earthing.

Such known protective measures are based solely on the principle of simply introducing a screening element between the source, i.e. the site of origin of the radiation, and the head of the respective user and producing a blocking effect for said user. This type of preventive measure is however no longer adequate, if more stringent requirements are specified to protect the health of the respective user, as the influence of such screening elements on the actually effective electromagnetic field distribution in the area of the head of the respective user remains largely undefined or simply random. effective electromagnetic field distribution in the area of the head of the respective user remains largely undefined or simply random.

Only one dual band antenna arrangement is known from EP 1 067 627 A1, which comprises a first antenna element for a first frequency band and a second antenna element connected capacitively to this for a second frequency band. When the first and the second antenna elements are arranged essentially in a second plane parallel to the first plane of their earth board or circuit board, the rectification efficiency of the antenna arrangement is improved and this can be associated with an improved SAR (specific absorption rate) response.

A folding mobile radio device is known from U.S. Pat. No. 5,572,223, in the hinge of which a first antenna is provided. This first antenna is positioned or directed away from the body of the respective user when the mobile radio device is unfolded, so that any disruptive impacts of the body of the user on radio signals during transmission or receiving are largely avoided. In both the unfolded and closed states, the first antenna is connected to the radio circuit in the main housing of the mobile radio device. It is only tuned to a specific operating radio frequency in the unfolded state. If the mobile radio device is closed, the first antenna in the hinge comes to rest in the area of the keypad above the main housing, with the result that the dielectricity constant in close range to the radio field of the first antenna changes due to the presence of the main housing and its internal components, such as for example electrically conducting transceiver circuits. In this way in the closed state the first antenna is no longer tuned to the defined operating radio frequency with the result that its transmitting/receiving power is reduced compared with the unfolded state. For this reason a second, parasitic antenna is provided in the main housing itself and is only connected to the first antenna, when the mobile radio device is closed up. Now this second antenna is tuned to the predetermined communication frequency of the transceiver circuit. An antenna system comprising two antennas in total is therefore provided, of which the first antenna is tuned to the predetermined communication frequency in the unfolded state and the second antenna is tuned to the predetermined communication frequency in the closed state.

The object of the invention is to demonstrate a way in which a radio communication device can be deployed with better control in respect of its influence on the body of a user when transmitting and/or receiving radio signals. This object is achieved with a radio communication device of the type referred to above in that at least one additional SAR value-reducing correction element is connected in and/or on the housing to the printed circuit board in such a manner that any electric current flowing on the printed circuit board is partitioned in a targeted manner away from its one or more local maxima to the correction element, so that when the radio communication device is used, the local distribution of the overall resulting electric current on the printed circuit board and the additional SAR value-reducing correction element taken together is homogenized and/or the respective, original current maximum is moved into an area of the device which is less critical for users.

By using the at least one additional correction element to partition the current flow away from the one or more local maxima on the printed circuit board to the correction element and thereby creating a sort of parallel circuit for current branching, the local distribution of the resulting electric current on the printed circuit board can be influenced in a targeted, i.e. controllable manner. More specifically the local distribution of the resulting electric current on the printed circuit board and the additional element taken together, i.e. in total, is homogenized and/or the original current maximum is moved into an area of the device which is less critical for users.

In this way it is possible in particular largely to avoid “hot spots”, i.e. tissue volume areas of higher thermal loading compared with tissue volume areas with lower heat levels, i.e. local fluctuations in the thermal loading of tissue volume areas—such fluctuations in the thermal loading of tissue volume areas—such as for example preferably in the sensitive head of the respective user when using the inventive radio communication device (e.g. a mobile radio or cordless telephone) appropriately. Organic tissue in the head of the respective user is thereby subjected, taken as a whole, at least to a more regular and/or lower level of thermal loading.

Unlike the known prior art the correction element according to the invention changes the original local distribution of the electric current flow on the printed circuit board so that current level is homogenized and/or the current level maximum or the current level maxima are at least moved to a less critical area of the device. Only then can the actual electromagnetic field distribution in close range of the respective radio communication device be deployed in a more controlled manner and the head, in particular the inside of the head, of the respective user can be better protected in a reliable manner from local hot spots. The electromagnetic radiation actually affecting the body of the respective user can therefore advantageously be controlled so that inadmissibly high local maxima of electromagnetic radiation or currents flowing as a result in the body tissue can be reduced to levels which are more favorable for the body and/or forced into a less critical area of the device.

Other developments of the invention are set out in the subclaims.

The invention and its developments are described in more detail below using drawings.

These show:

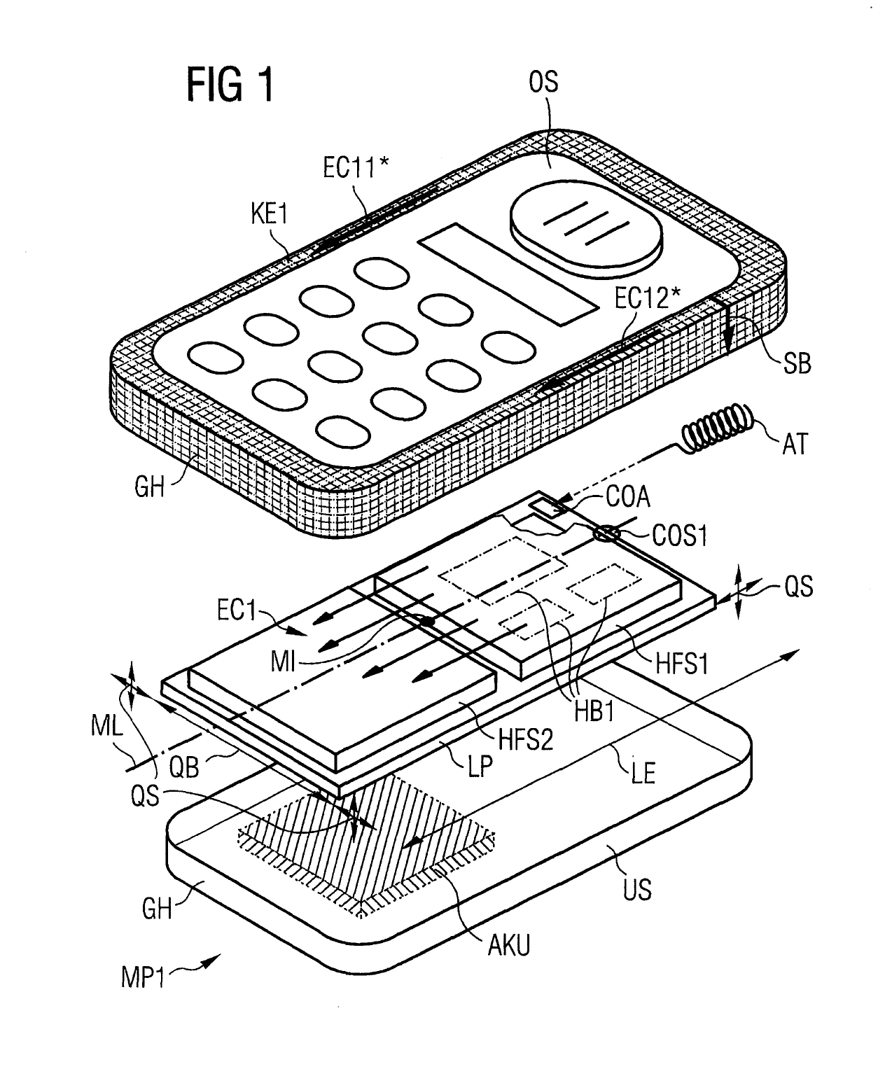

FIG. 1 a schematic illustration of a mobile radio device as the first embodiment of a radio communication device according to the invention with an additional SAR value-reducing correction element,

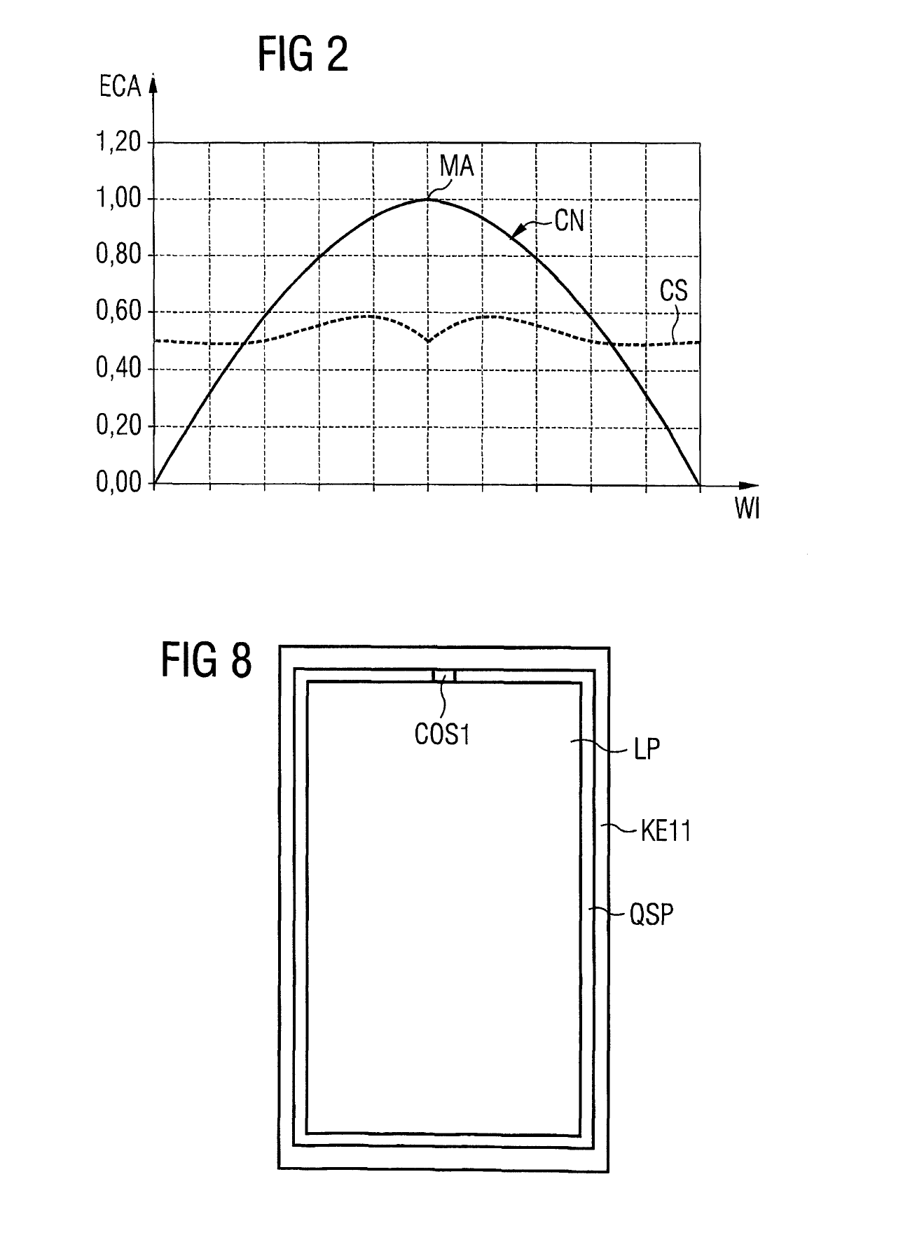

FIG. 2 a schematic illustration of a diagram of current distribution taken over the entire cross-section of the mobile radio device according to FIG. 1 with and without an additional SAR value-reducing correction element,

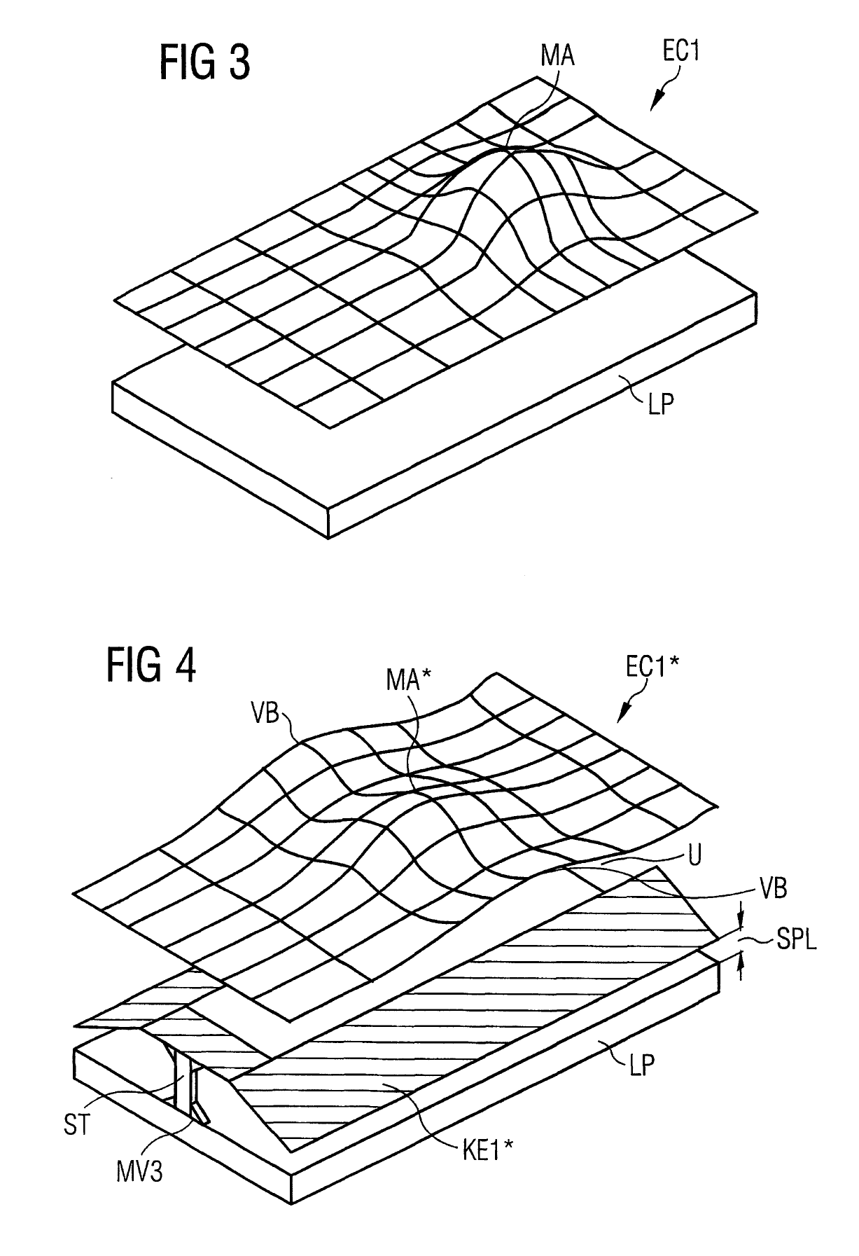

FIGS. 3 and 4 a schematic illustration of the local current distribution on the printed circuit board of the mobile radio device according to FIG. 1 without and with the additional SAR value-reducing correction element,

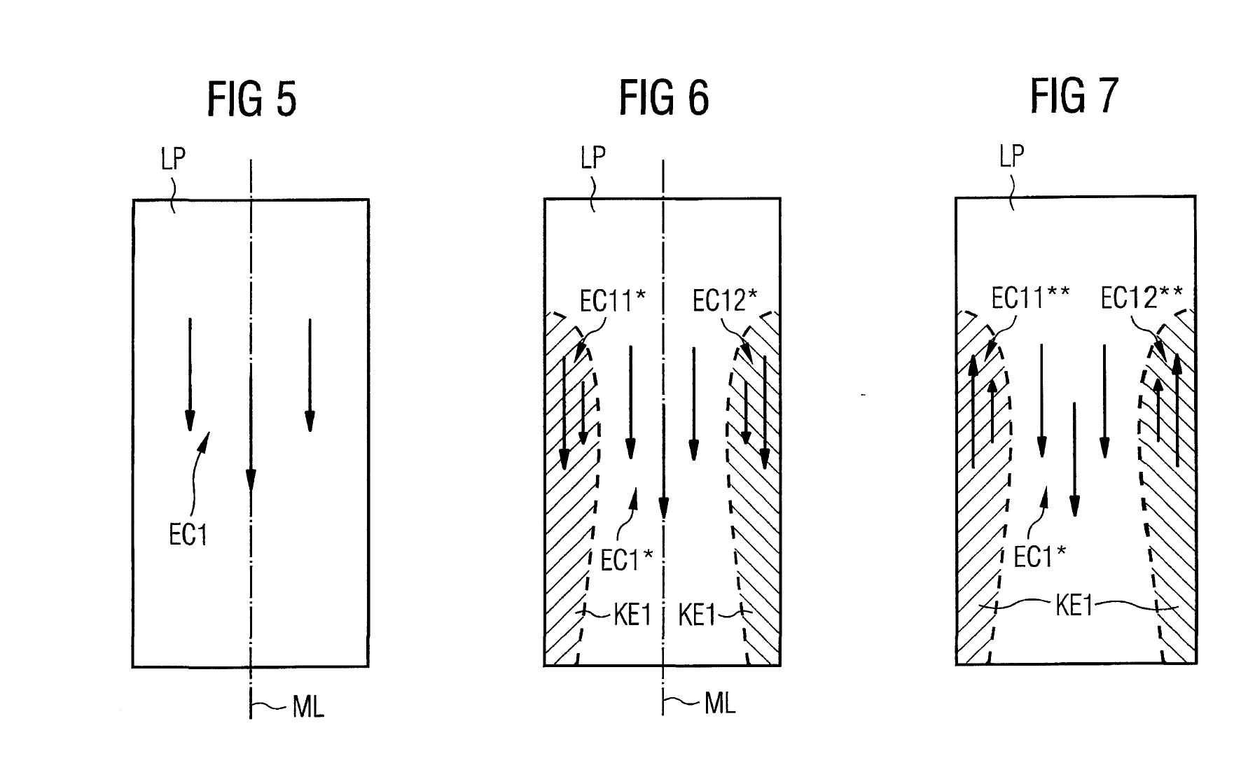

FIG. 5 a schematic illustration of the current flow field on the printed circuit board of the mobile radio device according to FIG. 1 without an additional SAR value-reducing correction element,

FIGS. 6, 7 two different variants for changing the amplitudes of the original local current flow distribution on the printed circuit board according to FIG. 5,

FIGS. 8 to 16 a schematic illustration of different variants of SAR value-reducing correction elements,

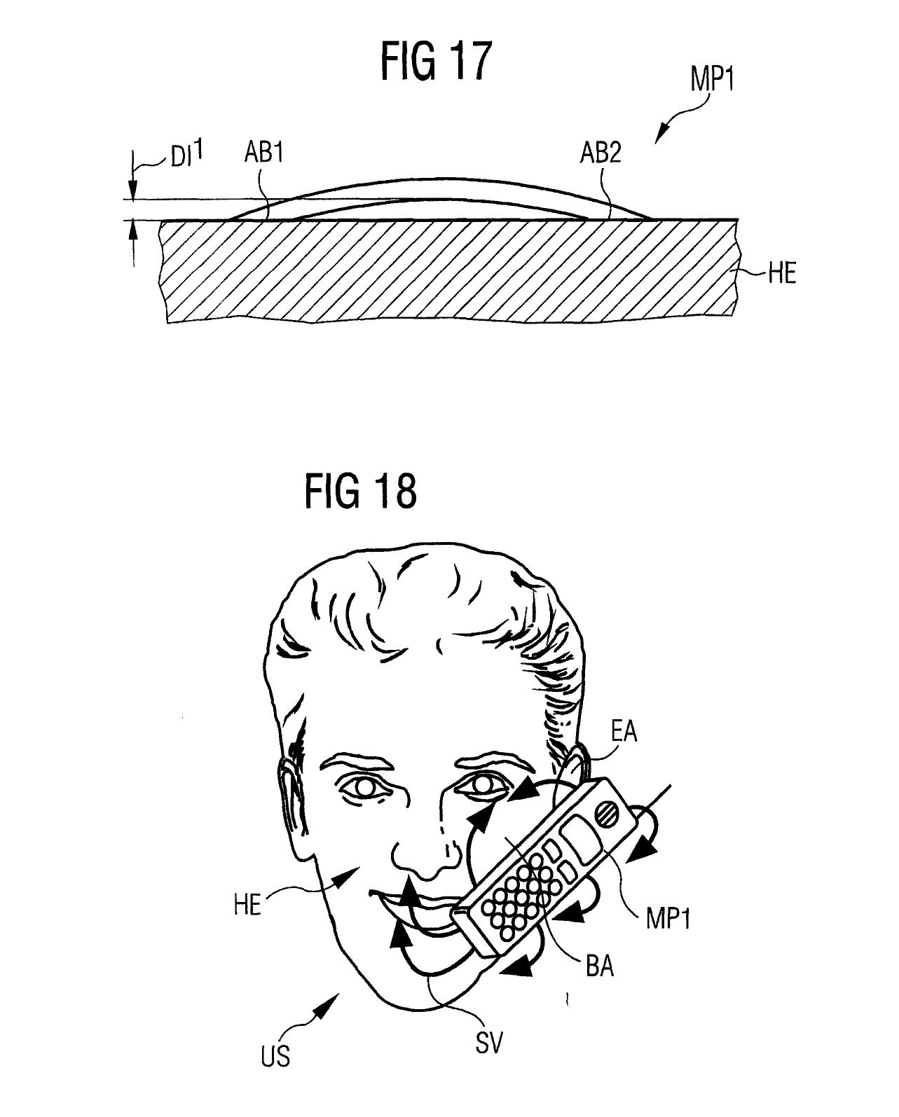

FIG. 17 a schematic illustration of an expedient housing form for a mobile radio device according to one of FIGS. 1 to 15, in order to reduce further the thermal loading due to what are known as hot spots in the head area of the respective user,

FIG. 18 a schematic illustration of the respective mobile radio device according to one of FIGS. 1 to 16 when used appropriately at the head of a user,

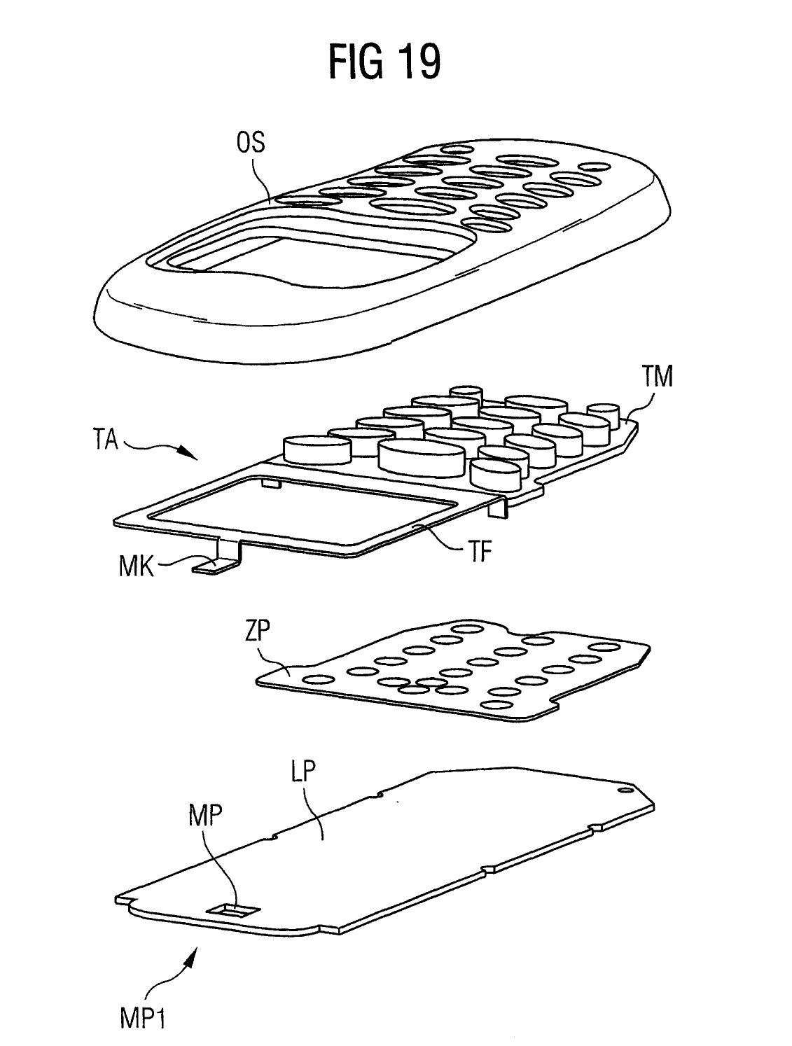

FIG. 19 a schematic and spatial illustration of different main components of a mobile radio device in a disassembled state, with at least one current-conducting intermediate layer as a component of its keypad mat to reduce SAR values, and

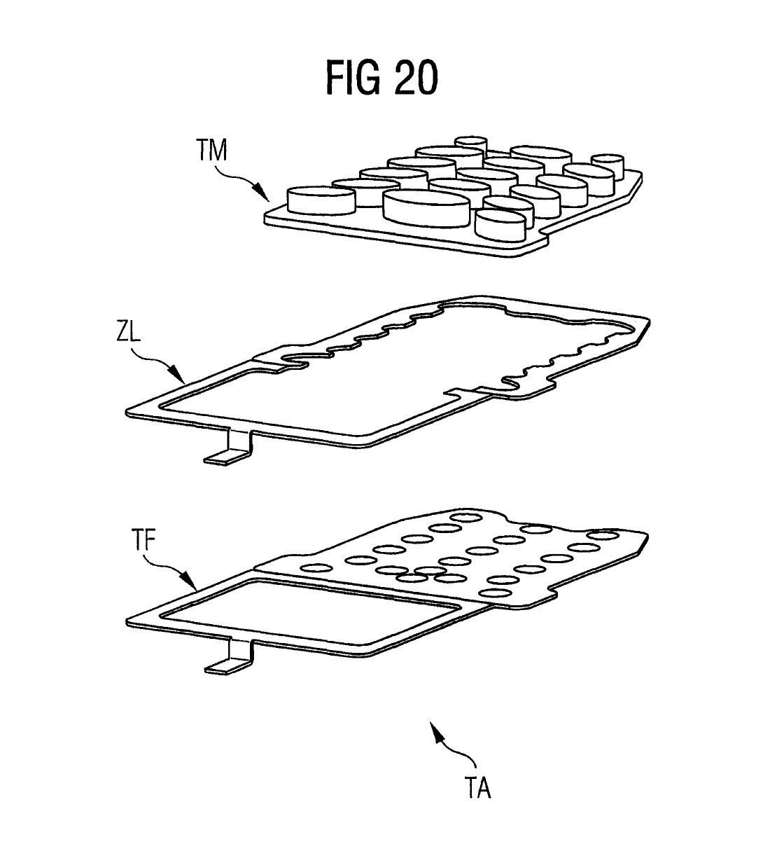

FIG. 20 a schematic illustration of the different main components of the keypad mat according to the invention for the mobile radio device according to FIG. 19.

Elements with the same function and effect are given the same references in FIGS. 1 to 20.

FIG. 1 shows a schematic and spatial illustration of a mobile radio device, in particular a mobile radio telephone or cordless telephone, as the first exemplary embodiment of a radio communication device MP1 according to the invention, which is shown broken down into three main components, i.e. the upper casing OS and the lower casing US of its housing GH and the printed circuit board LP housed therein. The housing GH is thus configured in two parts in the present exemplary embodiment. It has an essentially flat rectangular form. Its extension in the longitudinal direction LE is preferably selected to be greater than its extension in the transverse direction QB, i.e. its narrow side. The transverse direction QB and the longitudinal direction LE thereby form two coordinate axes of a Cartesian coordinate system QS, which are orthogonal in respect of each other, the third axis being formed by the thickness or height of the mobile radio device. In particular the housing is dimensioned in practice so that its length is between 6 and 15 cm, while its width is between 3 and 5 cm. The essentially flat and rectangularly configured printed circuit board LP is preferably dimensioned so that it can be housed in the housing GH. The upper casing OS and the lower casing US of the housing GH are preferably made from an electrically insulating material, such as plastic. This largely prevents an inadmissibly high attenuation of the transmission power of the mobile radio device MP1, as might result with a fully metallic or fully metallized housing due to any induction there of electromagnetic counter-fields (which could oppose the radiation field of the antenna AT).

The mobile radio device MP1 is preferably configured as a mobile radio telephone, which operates according to the GSM (global system for mobile communications), GPRS (general packet and radio service), EDGE (enhanced data rates for GSM evolution), UMTS (universal mobile telecommunication system) standards. It is preferably dimensioned so that it can be carried by a user and can therefore be located with the user at different places in the radio cells of such radio communication systems. In addition to or regardless of the telephoning function of such a mobile radio device it can also be expedient in some circumstances to use said device for other message/data transmissions via radio, e.g. image transmissions, fax transmissions, e-mail transmissions, etc. It can also be expedient in some circumstances to provide a cordless telephone, particularly according to what is known as the DECT standard, as the mobile radio device.

To receive and/or send radio signals, the printed circuit board LP in FIG. 1 has a high frequency module HB1 in its one half, the various components of which are shown schematically with broken lines. A transmitter/receiver antenna AT is connected to this high frequency module HB1 via a contact COA to emit and/or receive electromagnetic radio waves. It is supplied from there with energy from an energy supply unit AKU, in particular a battery or an accumulator. This energy supply unit AKU is also shown with a broken line in FIG. 1 in the area of the half of the printed circuit board LP opposite the antenna AT. It is preferably located in the lower casing US. Energy supply lines from this energy supply unit to the various components of the mobile radio device MP1 are omitted here for reasons of clarity.

In order to exclude incoming and outgoing radiation influences to a large extent during radio operation, the components of the high frequency module HB1 on the printed circuit board LP in FIG. 1 are encapsulated in an electromagnetic screening housing HFS1, which is permanently connected to the printed circuit board LP, in particular its earth layer, as a sort of cover over the high frequency module HB1. This creates an essentially cuboid screening chamber for the high frequency module HB1.

One or more electrical modules are housed in the second half of the printed circuit board LP in FIG. 1 in a further, corresponding electromagnetic screening housing HFS2. These are used to control the input and/or output elements of the mobile radio device MP1, such as its keypad, display, speaker, etc. as well as to process radio signals received via the high frequency module HB1 and/or to be sent out via said module.

In order now to protect a user US during appropriate use of the mobile radio device MP1 according to FIG. 18 to a large extent from potential health risks due to the electromagnetic radiation energy emitted by the high frequency module HB1 via the antenna AT, a large number of precautionary measures are implemented in practice. Thus it is expedient for example to target the main direction of radiation from the antenna AT or the high frequency module HB1 so that it is directed away from the head HE of the respective user US. Even if the overall radiation loading of the respective user is below the specified limit value as a result of such measures, it is however not known how and with what local distribution possible secondary or residual radiation fields affect the organic tissue in the head area of the respective user. What is known as the SAR (specific absorption rate) value is used in particular as a specific measurement criterion for the radiation loading to which the respective user is actually exposed (despite all precautionary measures). This gives the specific absorption rate in watts per kilogram, with which a predetermined tissue volume area, e.g. in the head of the respective user, is subject to thermal loading. The local thermal heating of individual tissue volume areas in the head of the user can be critical in so far as field-absorbing screening elements are often dimensioned and integrated in mobile radio devices in an uncontrolled manner, so that electromagnetic energy can be focused in an undesirable or unwanted manner on local tissue volume areas in the head of the respective user due to bending and/or resonance effects. Such elements are also generally positioned in the housing facing the respective user so that when the respective mobile radio device is used, they are closer than the antenna to the head of the user and can therefore have a greater impact on the electromagnetic radiation energy. Precisely such screening elements can also cause unintended secondary effects of local heating of specific tissue volume areas in the head of the respective user.

To determine the SAR values of mobile radio devices as a measure of the thermal heating of a specific tissue volume area, the measurement method, which is described in detail in the draft European standard EN 50361, is preferably used. Here the site of maximum thermal loading is established in the head of the respective user. The SAR value is then obtained from integration over a specific tissue volume inside the head between the cheek BA and the ear EA of the respective user US (see FIG. 18), i.e. approximately where the mobile radio device MP1 is positioned when used appropriately at the head HE of the respective user US. A tissue volume area in particular is selected as specified in the draft European standard EN 50361.

Extensive tests with a probe in a model head containing a glucose solution have now surprisingly shown that the thermal heating of the organic tissue in the head fluctuates or varies locally, i.e. there is a local distribution of maxima and minima. This locally variable thermal heating appears in particular to be due to a corresponding local current distribution EC1 on the printed circuit board LP. Such an electric current preferably flows on the printed circuit board LP along its longitudinal extension LE, when the transmitter/receiver antenna AT is configured as a λ/4 antenna and forms a radiation dipole together with the printed circuit board LP. FIG. 1 shows the local distribution EC1 of the current flow along the longitudinal extension of the printed circuit board LP by means of vector arrows. The longer the length of the respective vector arrow, the greater the associated current amplitude. The geometrical relationships of the printed circuit board LP in the form of a longitudinally extended rectangle mean that the greatest current amplitude or current density occurs along the central longitudinal axis ML around the center MI of the printed circuit board LP, i.e. in the area of the point of intersection of its diagonals, while the current density decreases towards the two longitudinal edges (starting from the center line ML). The current amplitude on the broad side is at a maximum in the area of the supply point COA of the antenna AT, where the λ/4 antenna is supplied with current. On the broad side of the printed circuit board LP opposite the antenna AT the current amplitude is however at a minimum, where the current flow is interrupted by the edge boundary. The electric field there however is at a maximum (corresponding to the electric e-field at the free end of the λ/4 antenna). The electric current in the exemplary embodiment therefore flows at its strongest around the central area or center MI of the printed circuit board LP, because the printed circuit board LP to an extent forms the counter-pole of a radiation dipole opposite the λ/4 antenna AT. In close range to this local current distribution EC1 this appears to generate or induce a corresponding electromagnetic field in the head of the respective user during appropriate use of the mobile radio device MP1. Close range here is the range below the wavelength λ/2π. For example in the GSM radio network with a frequency range between 880 and 960 MHz (mean frequency 900 MHz) the wavelength λ is approximately 35 cm. In the PCN (private commercial network) (e-network) with a frequency band between 1710 and 1800 MHz the wavelength is approximately 17 cm. In a UMTS communication system with a frequency transmission range between 1920 and 2170 MHz the wavelength λ is approximately 15 cm. While with the GSM radio system the local current distribution on the printed circuit board means that the penetration depth of the near field can be calculated as approximately 6 cm and with the PCN network approximately 5 cm, with a UMTS mobile radio device the penetration depth of the near field is approximately 2 to 4 cm due to the local current distribution on the printed circuit board LP. The smaller the local penetration depth into the brain tissue, the higher the measured SAR value can be with the same assumed transmission power of the antenna, as a higher electromagnetic field density, therefore a greater current flow and a higher level of thermal heating is produced for the predetermined tissue volume. Also with many housings (e.g. with metallic galvanization of the upper casing) the thermal heating of the tissue inside the head of the respective user is also produced directly by the local current distribution EC1 on the printed circuit board, as the respective mobile radio device MP1 is placed against the outside of the head of the respective user between said user's ear EA and cheek BA according to FIG. 18, so that electric, capacitive and/or inductive contact takes place and current can flow from the printed circuit board LP in some cases across the skin of the user and/or into said user's brain tissue.

In order now to be able to distribute electromagnetic radiation fields and/or electric currents due to them as well as the associated thermal loading, which could have an unfavorable effect in the head area of the respective user when the mobile radio device is used appropriately, in a more controlled manner in respect of their local distribution, at least one additional SAR value-reducing correction element is provided and configured in and/or on the housing so that any electric current flowing on the printed circuit board is partitioned in a targeted manner away from its one or more local maxima to the correction element. When the mobile radio device is used, the local distribution of the overall resulting electric current on the printed circuit board and the additional element taken together is homogenized. In addition to or regardless of this it can be advantageous to move the respective, original current maximum into an area of the device which is less critical to users. Such a less critical area of the device may for example be that area of the mobile radio device which is in the vicinity of the chin of the respective user, when the device is used appropriately.

Using at least one additional correction element to partition the current flow away from the one or more local current maxima on the printed circuit board to the correction element, thereby creating a sort of parallel circuit for current branching, means that the local distribution of the resulting electric current on the circuit board can be influenced in a targeted i.e. controllable manner. More specifically the local distribution of the resulting electric current on the printed circuit board and the additional element taken together can be homogenized and/or the respective original current maximum can be moved to an area of the device less critical for users.

In this way it is possible in particular to avoid to a large extent what are known as “hot spots”, i.e. tissue volume areas of higher thermal loading compared with tissue volume areas with lower heat levels, i.e. local fluctuations in the thermal loading of tissue volume areas—e.g. preferably in the sensitive head of the respective user when using the mobile radio device according to the invention appropriately. Organic tissue in the head of the respective user is then generally subjected to a more regular and/or lower level of thermal loading.

Such an additional correction element is used to change the original, local distribution of the electric current flow on the printed circuit board and on the correction element overall in particular so that homogenization is essentially achieved over the width of the printed circuit board in the transverse direction QB in respect of the current level at the longitudinal points of the printed circuit board and/or the original local position of the current level maximum or the current level maxima is moved at least to a less critical area of the device. Only then can the actual electromagnetic field distribution in close range to the mobile radio device be deployed in a more controlled manner, thereby improving protection to the head, in particular the inside of the head, of the respective user in a reliable manner from inadmissibly high local hot spots. The electromagnetic radiation actually affecting the body of the respective user can then be controlled advantageously so that inadmissibly high local maxima of electromagnetic radiation or currents flowing as a result in the body tissue are reduced to levels more favorable to the body and/or can be moved to a less critical area of the device.

In this way, when the mobile radio device is used, the local distribution of the overall resulting electric current (flowing in total on the printed circuit board and the correction element taken together) is homogenized in particular over the width of the printed circuit board. This means that there is also a more homogenous current distribution over the longitudinal direction of the printed circuit board. When the respective mobile radio device is placed against the head area of the respective user, any currents becoming active there in particular at the outside of the head and/or inside the head are largely homogenized. The at least one SAR value-reducing correction element according to the invention may not always be able to reduce the overall thermal loading in the head area of the respective user but at least the original current amplitude maxima can be reduced or equalized, i.e. distributed or partitioned to other tissue volume areas. Generally the energy becoming thermally active in the head of the respective user is distributed over a greater tissue volume, which results, on the evaluation by means of an integration volume of a finite, predetermined degree, in a reduction of the specifically assigned SAR value. Extensive tests have shown that any electric current, for example EC1, flowing on the printed circuit board, such as for example LP in FIG. 1, can be assumed to be causal in respect of the thermal heating of organic tissue in the head area of the respective user. Such an electric current flows in particular on the printed circuit board LP along its longitudinal extension LE, when the transmitter/receiver antenna AT is configured as a λ/4 antenna and forms a radiation dipole together with the printed circuit board LP. In some circumstances such a current flow on the printed circuit board can also occur with other antenna types—in some circumstances however with a different local distribution of maxima and minima. Generally speaking, an electric current can start to flow on the printed circuit board in all instances in which the antenna is configured as an electric counter-pole to the printed circuit board. Thus for example what is known as a PIFA (planar inverted F) antenna forms a radiation dipole together with the printed circuit board.

With the mobile radio device MP1 in FIG. 1 the SAR value-reducing correction element is formed by an electrically conductive element KE1, which runs round the periphery of the upper casing OS of the housing in the edge zone along its four side edges on the outside of the upper casing OS. Its position is shown by hatching. More specifically it covers both the edge zone area along the side edges of the rectangular upper side of the upper casing OS, as well as the sides of the upper casing OS molded down towards the lower casing US and essentially perpendicular to the upper side of the upper casing OS. The correction element KE1 extends along a zone in the area of the four adjacent side edges of the upper casing OS, while the other areas of the upper and lower casings OS, US remain free. The overall edge width SB of this correction element KE1 is expediently between 5 and 25% of the overall cross-sectional width QB of the printed circuit board LP.

The electrically conductive element used here is a single or multi-layer, electrically conductive film, coating or another electrically conductive surface element. It can in some circumstances also be expedient to provide one or more electrically conductive wires as the electrically conductive element KE1.

In particular such a correction element can also at the same time be used as a design element of the housing, e.g. a vapor-deposited or galvanized metal coating.

The correction element KE1 in the exemplary embodiment in FIG. 1 is in contact with the earth of the printed circuit board LP only at a single, electrical and mechanical contact point COS1. Along the remainder of its extension, when the mobile radio device MP1 is in its assembled state, it is arranged with a transverse gap QS in respect of all its side edges towards the printed circuit board, in other words there is no contact there between the printed circuit board LP and the correction element KE1. With the mobile radio device MP1 in FIG. 1 the contact point COS1 is in the area of the high frequency module HB1 of the printed circuit board LP, where the current supply is at a maximum. This means that current can be branched most effectively from the printed circuit board LP to the correction element KE1. The contact point COS1 is expediently arranged in the area of the central longitudinal axis ML of the printed circuit board LP shown with a broken line, so that largely symmetrical current partitioning results from the printed circuit board LP to the additional correction element KE1. This contact at the point COS1 allows some of the electric current to be diverted from the printed circuit board LP to the correction element KE1. As a result partial currents flow along the longitudinal sides of the upper casing OS onto the correction element strips applied there, shown by vector arrows EC11*, EC12*. These additional partial currents are essentially rectified to correspond to the electric current flow EC1 on the printed circuit board LP along its longitudinal extension LE.

FIG. 2 shows a diagram of the current distribution on the printed circuit board LP taken over its cross-section or broad side with and without the additional correction element KE1 from FIG. 1. The abscissa in the diagram shows the extension WI of the printed circuit board in the transverse direction, with the associated current amplitude ECA along the ordinates. The curve CN shows the current distribution taken over the cross-section of the printed circuit board. LP, when no correction element is provided. This curve shows a current maximum approximately in the center of the cross-section of the printed circuit board, while the current flow is at its smallest or a minimum at the two longitudinal side edges of the current flow. In this way the current distribution curve CN is essentially parabolic in form, with its crown roughly in the center of the cross-sectional extension of the printed circuit board LP.

Including the additional correction element produces a drop in the original current amplitude maximum MA to the extent that a homogenized, i.e. more homogenous, current distribution (see dotted curve CS in FIG. 2) results, taken over the cross-section of the printed circuit board LP together with the now connected correction element KE1, i.e. taken over the entire cross-section of the mobile radio housing GH the current amplitude of any perceptible overall electric current field is now approximately constant. An electromagnetic field, which is associated with a current flow with such an equalized current distribution, also shows essentially similar conditions over the cross-section of the mobile radio device MP1. In this way all too large graduated differences between the current amplitude values of local maxima and minima in the head of the respective user, i.e. in particular overheating points in local head tissue areas are largely avoided due to the homogenization of current distribution.

It can also be adequate in some circumstances not to select an encircling, ring-shaped closed structure for the correction element but for example to have a break in or omit completely a side edge of the ring-shaped structure of the correction element KE1 in FIG. 1, i.e. to select an open or broken or cross-slit structure. Preferably such a partial section or strip of the correction element is omitted or provided with an individual cross-slit or a number of cross-slits, i.e. a gap is inserted along the electrical conductor path of the correction element, where an additional current flow is not required for the required change to the overall current distribution of the mobile radio device.

FIG. 4 shows a correction element KE1* modified compared with FIG. 1 so that it has a break or slit U shown schematically and spatially, which only runs along three adjacent side edges of the upper casing OS. More specifically these are the correction element strips along the two longitudinal sides of the printed circuit board and its narrow side in the area of the current supply at the high frequency module. Compared with the correction element KE1 in FIG. 1, the modified correction element KE1* does not have the cross-connecting strip between the two longitudinal sides opposite the high frequency module of the printed circuit board LP. Even with such a modified correction element KE1*, with which three side strips are in contact with each other at 90°, there is essentially the same spatial current distribution as with the first correction element KE1. In FIG. 4 the local current distribution resulting from the insertion of the additional correction element KE1* is also shown three-dimensionally above the printed circuit board LP with the connected correction element KE1*. Compared with the original, spatial current distribution EC1 without a correction element, as shown schematically in FIG. 3, the additional correction element KE1* also effects a partitioning or deflection of the current flow from the main circuit board LP via an electrical and mechanical contact point MV3 to the additional correction element KE1*. This causes a drop in the original current maximum MA to a lower value MA*<MA. Therefore components of the original current flow on the printed circuit board LP are branched onto the longitudinal strips of the additional correction element KE1*. These longitudinal currents branched onto the longitudinal strips of the additional correction element are shown by vector arrows EC11*, EC12* in FIGS. 6 and 7. Branching the current flow to the correction element in this way increases the current level taken over the entire cross-section of the mobile radio device MP1 (i.e. printed circuit board LP together with connected correction element KE1*) in the area of the longitudinal side edges of the overall current field (=current field of the printed circuit board plus current field on the correction element) in the area of the longitudinal sides of the printed circuit board compared with the original current distribution there (without the additional correction element). This increase in current amplitude on the longitudinal sides of the overall resulting current field is designated in FIG. 4 as VB. With this variant the outer edges of the correction element KE1* are approximately congruent in respect of the side edges of the printed circuit board LP and in an approximately parallel plane to this with a difference in height.

This correction element KE1* is expediently part of the printed circuit board LP. In particular it is connected so that it can be curved around it. This facilitates manufacture and production processes, as the printed circuit board LP and the correction element KE1* can be manufactured together in a level plane. By simply bending through 180° the outer edges of the correction element KE1* can largely be made to cover the side edges of the printed circuit board LP, leaving a clearance SPL, i.e. a height difference in relation to the printed circuit board LP. This is achieved by connecting the correction element KE1* over a correspondingly long side lip ST to the printed circuit board LP, said lip being offset through around 90° in relation to the plane of the printed circuit board LP up to the upper casing OS when the printed circuit board LP is operational. When the printed circuit board LP is operational, the correction element KE1* is essentially in a plane parallel to the plane of the printed circuit board LP and is at a predetermined height difference SPL in respect of this.

Generally speaking the correction element is expediently positioned in relation to the printed circuit board so that it is in a spatial area in, above and/or below the printed circuit board assembly surface, which is limited by the side edges and the surface normals through these side edges. The respective surface normal is perpendicular or orthogonal to the printed circuit board assembly surface. This largely avoids any unwanted increase in the original surface dimensions (length and width) of the printed circuit board.

Adequate partitioning of the current flow from the maximum MA of the original., local current distribution EC1 on the printed circuit board LP (as shown in FIG. 4) to the additional correction element is in some circumstances still possible to an adequate degree, if a second contact is established with the correction element KE1 in FIG. 1 on the side of the printed circuit board LP opposite the first contact point COS1.

Generally speaking a partial section or strip of the correction element is preferably provided in the area of those points on the printed circuit board LP, at which an increase is required in the current level, in order to be able to achieve the required homogenization of the current level over the cross-section of printed circuit board and correction element taken together. This is preferably where the printed circuit board shows the current minima of its geometric current distribution.

With the two variants according to FIGS. 1 and 4, the respective correction element KE1 or KE1* is in contact mechanically and electrically in the area of the high frequency module HB1 of the printed circuit board LP with this latter. This results in a current flow along the longitudinal sides of the additional element, which is essentially rectified to correspond to the current flow on the printed circuit board LP. This is also shown in schematic form in FIGS. 5 and 6. The current amplitudes of the respective local current field are shown with vector arrows. The longer the length of the respective vector arrow, the greater the current amplitude. Without corrective measures the local current distribution EC1 on the printed circuit board LP has a current direction essentially parallel to the longitudinal sides of the printed circuit board LP. The maximum current amplitude is located roughly along the center line ML of the printed circuit board LP. Branching and deflecting the current flow across the contact point COS1 to the additional correction element KE1, the longitudinal sides of which run along a strip in the edge zone of the longitudinal sides of the printed circuit board LP, increases the current flow there overall, i.e. in total, as shown by the arrows EC11*, EC12*. At the same time this changes the local current distribution on the printed circuit board LP. The current distribution EC1* on the circuit board LP modified thus shows a reduction in current amplitude in the area of the center line ML. As the current flows EC11*, EC12* on the longitudinal strips of the additional element KE1 are essentially rectified to correspond to the current flow EC1* on the printed circuit board LP, a current level increase is effected overall, i.e. printed circuit board LP together with additional element KE1, in the area of the original minima of current distribution, so that the overall current distribution essentially has a constant current amplitude over the cross-sectional width of the mobile radio device. In this way the resulting overall current distribution, taken over the cross-section of the mobile radio device, is homogenized or equalized.

It can also be adequate for such homogenization of the current field taken over the overall cross-section (printed circuit board plus correction element) of the mobile radio device for just two separate strips to be attached in the area of the longitudinal sides of the printed circuit board LP as the additional correction element, each of said strips being connected individually both mechanically and in an electrically conductive manner to the printed circuit board LP at a contact point in the area of the high frequency module. These two electrically conductive individual strips are then expediently attached at a distance above the printed circuit board in a plane preferably largely parallel to this. Current partitioning according to FIG. 6 can then also be approximately achieved.

These two electrically conductive strip elements for correcting the resulting electric current distribution on the printed circuit board LP can, in some circumstances—for example if there is adequate space in the housing—also be arranged outside the base surface of the printed circuit board at a transverse distance from its two longitudinal sides essentially in the same level plane, and not essentially flush one above the other as shown in FIG. 1 and FIG. 3.

In the schematic top view in FIG. 8 the printed circuit board LP is surrounded by a rectangular, electrically conductive strip frame of a modified correction element KE11 in the same plane. Its electrically conductive strips form a closed edge running round the printed circuit board LP, which is offset to the contact point COS1 along its longitudinal extension with a continuous transverse gap QSP to the printed circuit board LP.

The fact that the correction element such as for example KE11 is only in contact with the printed circuit board LP at a single point means that more than simple peripheral widening of the printed circuit board is achieved, as with continuous peripheral contact between the additional element and the printed circuit board. Such a peripheral widening of the printed circuit board with continuous through contact would only result in a small widening of the original cross-sectional profile and thereby a certain drop in its current maximum in the center of the printed circuit board but would in practice generally have too minimal an effect. In particular the unwanted characteristic current level cross-sectional profile corresponding to the parabolic form of the curve CN according to FIG. 2 with the marked maximum would essentially be maintained.

In addition to or regardless of the galvanic connection of the correction element by means of the mechanical/electrical contact point to the printed circuit board, it can also be adequate in some circumstances to provide a current branch from the printed circuit board to the correction element by means of a capacitive and/or inductive connection and/or an electromagnetic radiation connection in a corresponding manner, in order to achieve the required local current distribution. Practical tests have shown that the mechanical/electrical connection of the correction element to the printed circuit board allows the most effective current branching or current deflection effect.

In some circumstances it can also be adequate to attach the correction element KE1 to the inside of the upper casing OS in addition to or regardless of housing said correction element KE1 on the upper side of the upper casing OS.

Tests have also shown that when the correction element KE1 in FIG. 1 is in contact with the transverse side of the printed circuit board LP opposite the high frequency module HB1, a current field EC11**, EC12** starts to flow on the two longitudinal strips of the correction element KE1, in the opposite direction to the original current flow EC1 on the printed circuit board LP. This is shown schematically in FIG. 7. Here too, despite the opposing direction of the current flows EC11*, EC12** on the two longitudinal strips of the correction element KE1 and the residual current flow EC1* on the printed circuit board LP, homogenization of current distribution is achieved, taken over the entire cross-section of the mobile radio device MP1. For here too part of the original flow on the printed circuit board LP is branched in particular from the area of the center line ML, i.e. where the maximum occurs with the original current distribution, to the correction element KE1. Thermal heating of tissue material due to in admissibly high local hot spots is thereby largely avoided. In particular the thermal heating of head tissue material can be partially reduced or homogenized by partially compensating for the electromagnetic field, which is produced by the current distribution on the printed circuit board, by electromagnetic counter-fields, which result from the countercurrent fields on the correction element.

To summarize, extensive experimentation has shown the following surprising link:

The SAR value primarily depends on the current maximum of the electric current field flowing over the cross-section of the mobile radio device taken as a whole and its proximity to an absorption point in the head of the respective user. It has been found that in principle there are two options for reducing this specific SAR value. A first option is to move the respective current maximum away from an absorption point. A second option is to reduce the current maximum by a distribution by means of equalizing currents. FIG. 2 shows the current distribution approximately in the center of the mobile radio telephone with (CS) and without (CN) an additional conductor path. This additional conductor path reduces the current maximum, depending on the design, preferably to around ⅔ to half of the initial value. The specific SAR values are also reduced correspondingly. There is no point in practice in applying the additional conductive layer (=correction element) continuously to the entire upper casing OS, since as the contact of the conductive layer increases, roughly the same current distribution profile occurs as without said conductive layer. A suitable conductor width is preferably in the range between 5 and 25% of the width of the printed circuit board. The additional conductive layer expediently makes contact in the upper area of the device in the area of the high frequency module HB1 and the printed circuit board LP. A symmetrical connection is preferable, as this results in largely symmetrical current partitioning to the additional conductive layer on both sides of the longitudinal sides of the printed circuit board LP. This results in optimal homogenization of current distribution across the entire cross-section of the mobile radio device taken as a whole. Contact with the high frequency module HB1 also means that a sufficiently large number of current components can be deflected to the correction element, as the energy is supplied there in the area of the high frequency module. In this way the transmission power and/or receiving power of the mobile radio device are also essentially maintained. This can in particular also be due to the fact that the electric current flows are essentially rectified both on the correction element and on the printed circuit board.

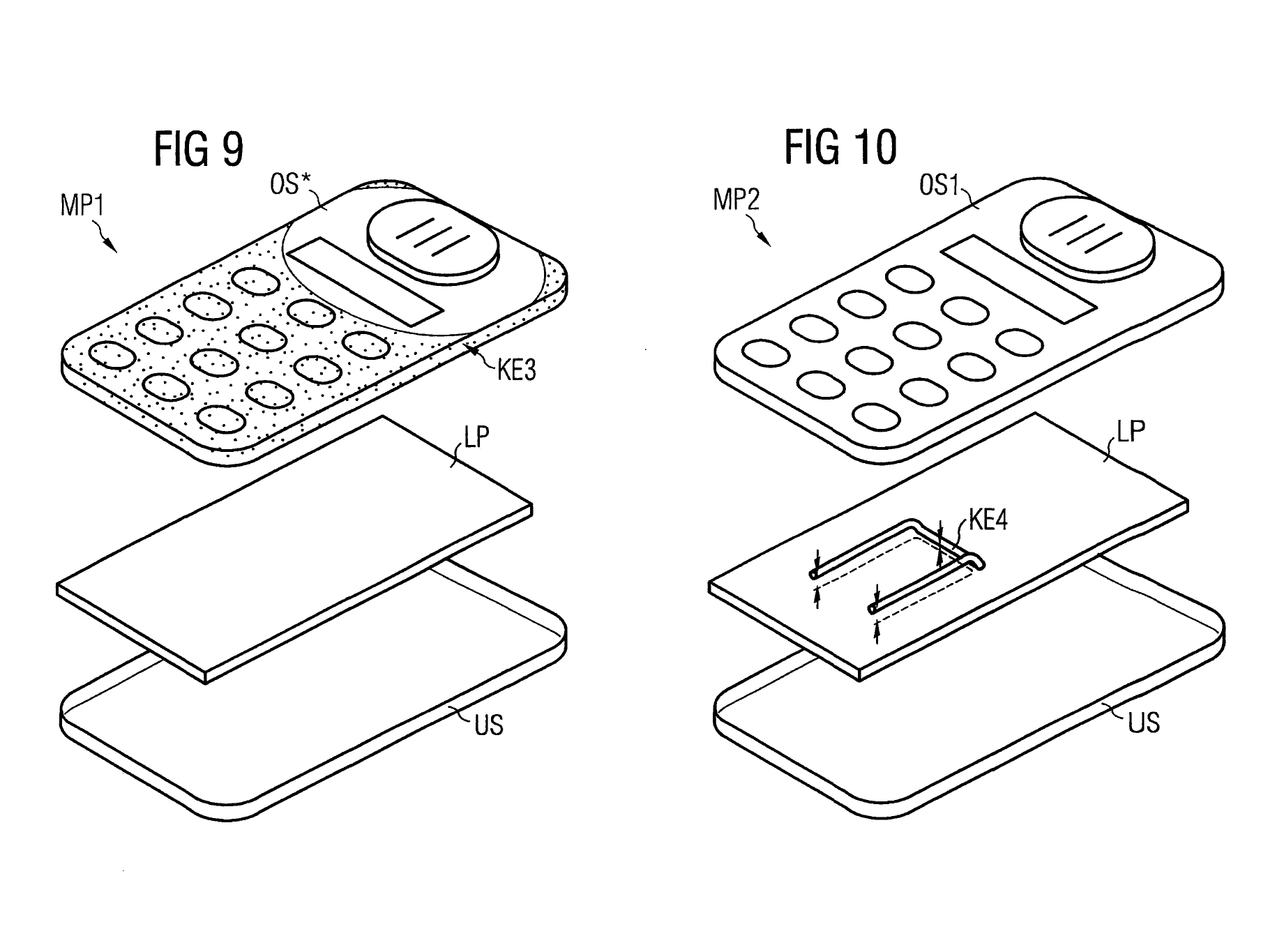

FIG. 9 shows the mobile radio device MP1 in a disassembled state, with the upper casing OS* here having electrically conductive galvanization KE3 on its upper and/or lower side, unlike in FIG. 1. Its layer thickness, conductivity, form and/or other parameters are expediently selected so that the required partitioning of the electric current flowing on the printed circuit board LP away from its one or more local maxima to the correction element KE3 is achieved, so that homogenization of the local distribution of the resulting electric current results overall taken over the cross-section of the mobile radio device MP1, i.e. taken over the entire cross-section of the mobile radio device MP1 a largely constant or at least a more homogenous total current amplitude results than without a correction element.

In some circumstances it can also be expedient to provide one or more electrically conductive wires instead of one flat electrically conductive correction element, such as for example KE1 in FIG. 1.

FIG. 10 shows a mobile radio device MP2 in a disassembled state with its upper casing OS1, its lower casing US and the printed circuit board LP housed between. Unlike the correction elements in FIGS. 1 to 9 a wire KE4 is housed here between the upper casing OS1 and the printed circuit board LP as an additional, SAR value-reducing correction element. This wire KE4 is expediently configured so that the one or more maxima of the local current field on the printed circuit board LP can largely be equalized, so that, taken over the cross-section, homogenization of the current amplitude results. The electrically conductive wire KE4 can have many curved shapes, diameter dimensions, different partial section distances and different partial section conductive capacities for this purpose, depending on the predetermined local current flow constellation with maxima and minima distribution. One or more such wires inside the mobile radio device MP2 can correct the predetermined local distribution of the printed circuit board current with corresponding positioning, form, conductivity, configuration so that taken over the entire cross-section of the mobile radio device MP2 approximately the same current amplitude is deployed at all cross-section points.

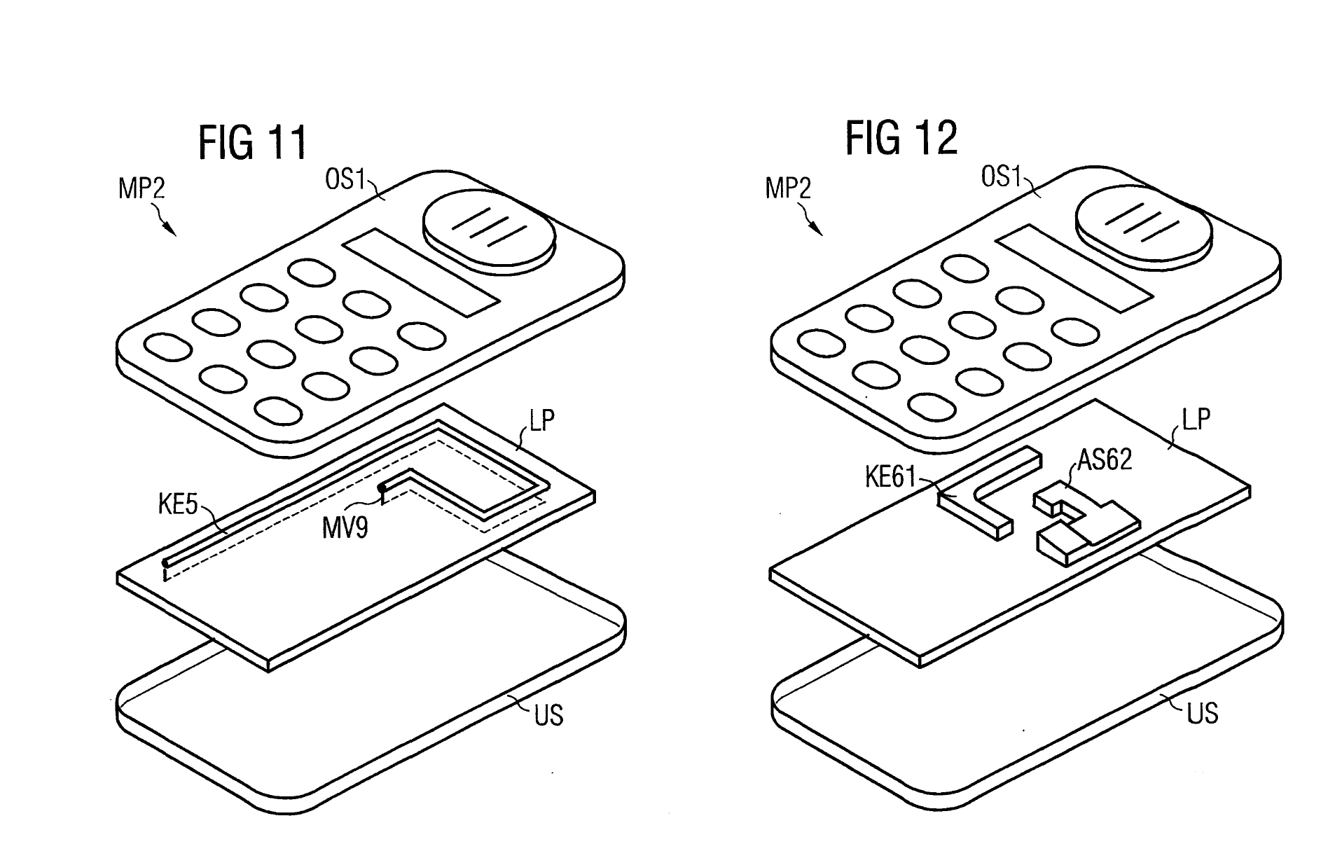

In FIG. 11 a conductor is provided as the SAR value-reducing correction element KE5 and this is for example curved into an L-shape. This has contact with or a connection MV9 to the earth of the printed circuit board LP. The wire KE5 is curved so that it is arranged in a plane parallel to the printed circuit board LP at a distance above the printed circuit board LP. Its fictional projection orthogonal to the assembly surface of the printed circuit board is therefore within these side edges.

In addition to or regardless of electrically conductive correction elements, it can also be expedient in some circumstances to provide at least one magnetically and/or dielectrically active body in and/or on the housing GH of the respective mobile radio device. In FIG. 12 for example a magnetic lossy material KE61 is applied to the printed circuit board LP inside the housing of the mobile radio device MP2. A dielectric body KE62 is also arranged there on the printed circuit board LP. The magnetically and/or dielectrically active body KE 61 or KE62 can also be partially metallized as an option.

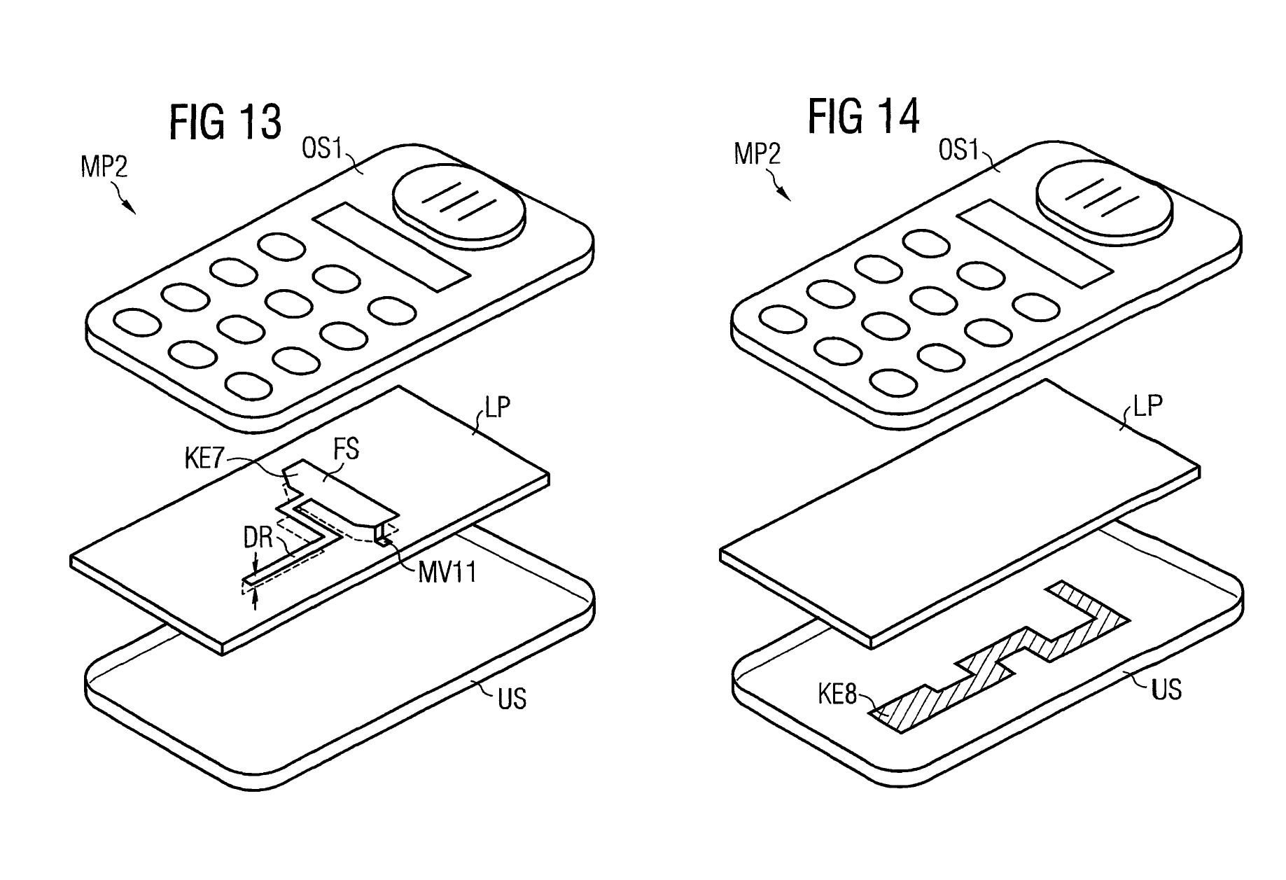

FIG. 13 shows a further SAR value-reducing correction element KE7 for the mobile radio device MP2. This correction element comprises a flat structure FS and a longitudinally extended wire DR applied to this. The correction element KE7 is in contact via an earth contact MV11 with the printed circuit board LP. The correction element KE7 is arranged at a predetermined distance in a plane above the printed circuit board LP and approximately parallel to this. It is therefore positioned in a spatial area, which is limited by the assembly surface of the printed circuit board LP and the fictional surface normal at the side edges of the printed circuit board.

FIG. 14 finally shows a further variant of a correction element according to the invention. A resistant film with a flat structure is integrated in the housing of the mobile radio device MP2 on the inside of the lower casing US. Its electrical conductivity, form and configuration and/or other specific parameters are preferably selected so that it influences the predetermined, local current distribution on the printed circuit board taken over the cross-section according to the invention.

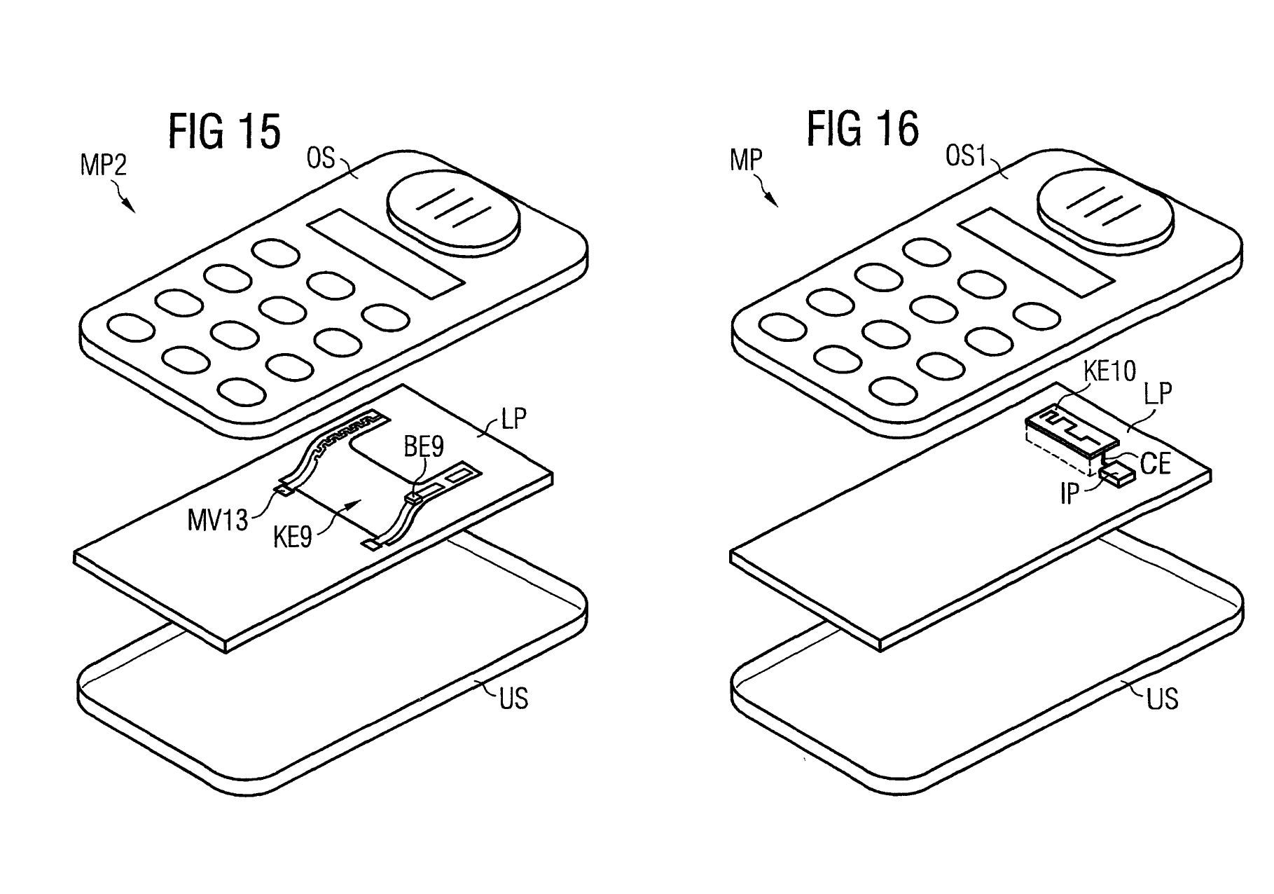

FIG. 15 shows a schematic diagram of how the correction element according to the invention can also be formed in some circumstances by a film KE9 printed with conductive structures. One or more discrete structural elements can be applied to this. In FIG. 15 the printed film KE9 is in contact via the contact point MV13 with the earth of the printed circuit board LP.

According to FIG. 16 it can also be expedient to attach a resonant antenna structure KE10 to the printed circuit board LP. This resonant antenna structure is connected in FIG. 16 via a contact element CE to an impedance component IP to adjust the impedance. Such a resonant antenna structure allows printed circuit board currents to be deflected in a targeted manner and their original field distribution to be changed as required.

To summarize, the respective correction element is positioned according to the exemplary embodiments in FIGS. 1, 4, 9-16 expediently in relation to the printed circuit board so that it is located in a spatial area in, over and/or below the printed circuit board assembly surface, which is limited by the side edges and the surface normals through these side edges. The respective surface normal is perpendicular or orthogonal to the printed circuit board assembly surface. In this way unwanted enlargement of the original surface dimensions (length and width) of the printed circuit board is largely avoided, so that the original, miniaturized structure of the respective mobile radio device can be largely maintained.

In all exemplary embodiments the respective correction element is configured and attached in respect of the printed circuit board so that current branching is achieved from the original printed circuit board areas with higher current amplitude values to those areas of the printed circuit board originally with lower current amplitude values and overall, i.e. taking the current distribution on the circuit board and correction element as a whole, a more homogenous overall current distribution results than before without an additional correction element.

The SAR value-reducing correction element principle according to the invention, shown as an example using mobile radio devices according to FIGS. 1-18, can of course be transferred to and used accordingly with cordless telephones and other radio communication devices.

Generally speaking, the originally predetermined current or field distribution, which is primarily due to the electric currents flowing on the printed circuit board, can advantageously be reduced at or in the head of the user or can be distributed differently in a manner which is more favorable to the body, by expediently implementing the following measures individually or in groups:

1. Integration of one or more electric wires, which can also have higher ohmic components, in the housing of the mobile radio device to be subject to SAR value reduction. These can be at a different height from the other parts of the device. They could also for example be inserted, glued into or pressed into and/or attached using what is known as SMD or MID technology to the lower or upper casing. External application is also possible.

2. Integration of magnetically and/or dielectrically active materials (with any linear curvature, flat with any curvature) into the housing of the respective mobile radio device. These may be at a different height or a transverse distance in respect of the other parts of the device. They could for example also be inserted, glued into, pressed into or attached to the lower or upper casing. Partial metallization can also be expedient to deploy the required field distribution. External application to the housing is also possible.

3. A combination of 1 and 2.

4. Contact (single, multiple and combinations) of the materials from 1, 2 or 3 at the earth surface or “hot conductor” of the transmitter (see FIGS. 1, 4).

5. Modification of the electrical characteristics of the lower or upper casing by changing the conductivity of the magnetic characteristics or the capacitive characteristics, and any combinations of these. This can be generated for example by integrating lossy or conductive, magnetic and/or dielectric particles, or mixtures of such. Partial or full coating of the outer skin with corresponding materials is also possible (see FIG. 9).

6. Multi-layer solutions to 1 to 5 are expedient in some circumstances.

7. It is also possible to provide a substrate, which is structured like a printed circuit board (PCD), which can be integrated and in some cases can make contact with parts of the device (see FIGS. 15, 16).

8. According to 7 with one or more additionally assembled discrete components on this substrate (see FIG. 15).

9. The wiring of a contact element of any configuration with a switching circuit (electrical matching network) to earth or to the “hot conductor” of the transmitter (see FIG. 16).

10. Any devices to hold the integrated structure, in order to achieve the required height difference or transverse distance in respect of other parts of the device.

In addition to or regardless of these such correction elements it can in some circumstances be expedient to shape the housing of the respective mobile radio device, e.g. MP1 in FIG. 1, so that the distance DI1 from the area of contact at the head HE of the respective user, where the respective current maximum occurs, is as large as possible. In FIG. 17 this is achieved for example by the housing of the mobile radio device MP1 having an inside surface curving in a convex manner outwards from the head HE and only coming into contact at its two outer edges AB1, AB2 with the head HE of the respective user in FIG. 18. This means that the mobile radio device MP1 has to be kept furthest away from the head of the user where the original current distribution on the printed circuit board is at a maximum, specifically in the central area of the mobile radio device.

Specifically during communication using mobile radio devices in particular, said devices emit electromagnetic waves. Some of these electromagnetic fields can in some circumstances also penetrate human tissue. In some circumstances this can lead to thermal loading in the human tissue. What is known as the SAR (specific absorption rate) value can be used to evaluate such thermal heating. Corresponding limits are specified in standards (e.g. EN 50360). With the ever increasing reduction of device dimensions the output radiation from mobile radio devices is increasingly concentrated in an increasingly small area, so that an increasing thermal load can result even when a mobile radio device is used appropriately at the head of a user. The areas of maximum thermal loading (known as hot spots) thereby primarily determine the SAR value. Even if these limit values are complied with, it is desirable to provide radio communication devices with the lowest possible SAR value.

This problem is resolved with a radio communication device according to a development of the invention, in which at least one current-conducting intermediate layer is provided in the form of a component of the keypad mat of the radio communication device as a SAR value-reducing correction element.

The additional, current-conducting intermediate layer means that the SAR value of the respective radio communication device can be reduced simply, while it remains possible at the same time to retain the originally predetermined dimensions and the design of the respective radio communication device.

A further development of the invention relates to a keypad mat with at least one current-conducting intermediate layer to reduce the SAR value of a radio communication device according to the invention.

FIG. 19 shows a mobile radio device MP1 with its main components in a disassembled state. Accommodated in its housing is a printed circuit board LP, which has corresponding modules and/or components to generate, process and evaluate radio signals to be sent and/or to be received. These have been omitted in FIG. 19 to simplify the diagram. Only the upper casing OS of the housing is shown in FIG. 19, while its lower casing is omitted for purposes of clarity. The upper and lower casings form a suitably shaped chamber for the printed circuit board LP in the assembled state, in order to be able to hold the printed circuit board securely. Conductor paths and/or structural elements of this printed circuit board LP are associated with the keys of a keypad mat TA, with which tactile, mechanical input/output activities based on key activation can be converted to electrical signals on the printed circuit board LP. The keypad unit TA comprises a support film TF, on which a keypad unit TM is arranged with a number of key elements. The support film TF is preferably configured as a flat support layer. It has an outer contour, which preferably corresponds to the outer contour of the printed circuit board LP. The support film TF is essentially configured as intact in the area of the keypad mat TM, while in the area of the display of the mobile radio device MP1 it has a suitable, in particular a rectangular, recess. According to FIG. 20 there is also a current-conducting intermediate layer ZL between the support film TF and the keypad unit TM. This intermediate layer ZL forms a sort of closed loop or a closed ring in the area of the four edges of the support film TF. When the mobile radio device is in the assembled state, the intermediate layer ZL forms a frame, located above the printed circuit board LP at a different height from and congruent to its periphery. The current-conducting intermediate later ZL is mechanically and electrically connected in the area of that front face of the printed circuit board LP to its earth contact MP via a contact lip MK (see FIG. 19). In this way a sort of parallel circuit is created between the printed circuit board LP and the current-conducting intermediate layer ZL, so that components of any current flowing on the printed circuit board LP along its longitudinal direction can be branched onto the two longitudinal sides of the frame shape of the intermediate layer ZL. Such targeted current branching due to the parallel circuit between the printed circuit board LP and the current-conducting intermediate layer ZL can change the local distribution of the resulting electric current on the printed circuit board in a controlled manner according to the inventive principle as set out in the previous examples and can in some circumstances homogenize said local distribution taken over the entire cross-section of the mobile radio device.

To summarize, a current-conducting intermediate layer is provided in the form of a component of a keypad mat as the SAR value-reducing correction element. A silicon mat, with a number of preformed key elements, is preferably used as the keypad mat. What is known as a polydome film is preferably used as the support film TF, made in particular from an electrically insulating material. In the exemplary embodiment in FIG. 20 the current-conducting intermediate layer ZL is configured between the polydome film and the silicon mat with the key elements as a closed ring around the display and keypad area, to form a sort of closed frame like a cover to the outer periphery of the support film. A copper film is used here as the current-conducting intermediate layer ZL. It is connected to earth via a contact lip MK, which is pressed over the housing OS onto an earth pad MP of the printed circuit board LP. In this example the polydome film TF serves as the support, protection and assembly aid for the current-conducting intermediate layer ZL and its outer contours are matched to the required geometry of the intermediate layer. The copper film is preferably glued to the polydome film so that the current-conducting intermediate layer is between the silicon body and the polydome film in the area of the key body. The intermediate layer is thereby insulated electrically on its lower side and has short circuit protection towards the printed circuit board LP. Below this electrically insulating support film TF in the exemplary embodiment in FIG. 19 a key connection mat ZP is provided, with electrically conductive pressure elements, which are associated with the keypad mat TM. These pressure elements convert the mechanical key strokes of the keypad mat TM into electrical breaks or conductor shorts on the printed circuit board LP. Insulating the current-conducting intermediate layer ZL electrically on its underside by means of the support film TF, gives a greater freedom of variation for the current-conducting intermediate layer, as the metallized intermediate layer ZL can be located above electrical contact surfaces of the connection mat ZP and an undefined earth connection in this area is largely avoided.

In principle the additional current-conducting intermediate layer can be integrated for SAR reduction purposes into any type of keypad mat, as according to the product-specific requirements:

1. Any element of a keypad mat (e.g. silicon mat, metal dome foil, spacer film, adhesive film, etc.) can be a support for the current-conducting intermediate layer;

2. The current-conducting intermediate layer can vary in material (current-conducting) and manufacture (e.g. vapor deposited or stamped, glued, galvanized, clad, etc.);

3. The configuration of the current-conducting intermediate layer can be adjusted taking into account the device design with regard to contour and geometry (e.g. two-dimensional, closed or open in a ring shape, branched, etc.) and/or its thickness can be adjusted based on the form and configuration of the printed circuit board;

4. The connection of the current-conducting intermediate layer can be adjusted in respect of configuration, number and position and it can be configured as an integrated or additional contact element.

5. The contact partner can be varied, as long as it is connected to the earth of the printed circuit board.

The additional current-conducting intermediate layer allows the SAR value to be reduced in an economical manner. In particular a copper film can also be laminated onto the support film of the keypad mat as an intermediate layer. This has the advantage of low material costs, low tool costs, thinness of structure (vapor-deposited copper layer of less than one micrometer). At the same time there is a wide range of configurations available, without restricting other characteristics of the device or of the device design. In some circumstances the additional, metallized and earthed surface can to some extent achieve the required electromagnetic interference resistance (ESD=electrostatic discharge) of the respect mobile radio device in a structural manner. Individual ESD protection components can therefore be dispensed with. Also this concept according to the invention has the advantage that, depending on the design of the earth connection, when the device is finally assembled, it may not be necessary to integrate an additional additive component.

The current-conducting intermediate layer may be a component of the keypad mat not only of a mobile radio device, in particular a mobile telephone, but also of other radio communication devices, such as for example cordless telephones such as DECT telephones, mobile notebooks with a radio interface, etc.

1. Radio communication device (MP1) with a housing (GH) and at least one printed circuit board (LP) housed therein, and with at least one transmitter/receiver antenna (AT) to send and/or receive radio signals,
characterized in that
at least one additional SAR value-reducing correction element (KE1) is connected in and/or on the housing (GH) to the printed circuit board (LP) so that any electric current (EC1) flowing on the printed circuit board (LP) is partitioned in a targeted manner away from its one or more local maxima (MA) to the correction element (KE1), so that when the radio communication device (MP1) is used, the local distribution of the overall resulting electric current on the printed circuit board and the additional SAR value-reducing correction element (KE1) taken together is homogenized and/or the respective original current maximum (MA) is moved into an area of the device which is less critical for users.

2. Radio communication device according to claim 1,
characterized in that
the radio communication device is a mobile radio device (MP1), in particular a mobile telephone or cordless telephone.

3. Radio communication device according to one of the previous claims,
characterized in that
the printed circuit board (LP) has a high frequency module (HB1), to which the at least one transmitter/receiver antenna (AT) is connected.

4. Radio communication device according to claim 3,
characterized in that
the high frequency module (HB1) is encapsulated in an electromagnetic screen (HFS1).

5. Radio communication device according to one of claims 3 or 4,
characterized in that
the antenna (AT) is configured so that it forms an electric counter-pole to the printed circuit board (LP).

6. Radio communication device according to one of claims 3 to 5,
characterized in that
the transmitter/receiver antenna (AT) is configured as a λ/4 antenna or a PIFA (planar inverted F) antenna, which forms a radiation dipole together with the printed circuit board (LP).

7. Radio communication device according to one of the preceding claims,
characterized in that
the correction element (KE1) is in mechanical and/or electrical contact with the printed circuit board (LP).

8. Radio communication device according to claim 7,
characterized in that
the correction element (KE1) is in electrical and/or mechanical contact with the printed circuit board (LP) at only one or a maximum of two points (COS1, COS2).

9. Radio communication device according to claim 8,
characterized in that
the contact point (COS1) of the correction element (KE1) is provided in the area of the high frequency module (HB1) of the printed circuit board (LP).

10. Radio communication device according to one of claims 8 or 9,
characterized in that
the contact point (COS1) is arranged in the area of the central longitudinal axis (ML) of the printed circuit board (LP), so that largely symmetrical current partitioning results from the printed circuit board (LP) to the additional correction element (KE1).

11. Radio communication device according to one of the preceding claims,
characterized in that
the correction element (KE1*) forms part of the printed circuit board (LP).

12. Radio communication device according to one of the preceding claims,
characterized in that
the correction element (KE1*) is connected mechanically/electrically, capacitively and/or inductively to the printed circuit board (LP) so that it can be positioned inside the housing (GH) within a space limited by the side edges of the printed circuit board (LP) above and/or below the latter's assembly surface.

13. Radio communication device according to one of the preceding claims,
characterized in that
the correction element (KE1) is arranged largely with symmetry of axis in respect of the central longitudinal axis (ML) of the printed circuit board (LP).

14. Radio communication device according to one of the preceding claims,
characterized in that
the additional correction element (KE1) is provided and configured in and/or on the housing (GH) so that one or more maxima (MA) in the local current distribution (EC1) on the printed circuit board (LP) can be reduced in a targeted manner in such a way that a SAR value results for the electromagnetic residual field becoming active at the user, which is reduced by between 30% and 70% compared with the original SAR value.

15. Radio communication device according to one of the preceding claims.
characterized in that
the housing (GH) is formed so that the distance (DI1) between the contact area of the radio communication device (MP1) at the head (HE) of the respective user (US) and the source(s) of the mobile radio device (MP1) producing the SAR value is increased so that the required reduction of the original SAR value is achieved.

16. Radio communication device according to one of the preceding claims,
characterized in that
the additional correction element (KE1) is configured and arranged so that the electric current partitioning means that the electric current flows (EC1*, EC11*, EC12*) on the printed circuit board (LP) and on the correction element (KE1) are essentially rectified.

17. Radio communication device according to one of claims 1 to 15,
characterized in that
the correction element (KE1) is configured and arranged so that the electric current partitioning means that the electric current flow (EC1*, EC11*, EC12*) on the printed circuit board (LP) and on the correction element (KE1) is essentially of opposing phases, bringing about a compensation effect for the original electromagnetic field brought about by the current flow on the printed circuit board (LP).

18. Radio communication device according to one of the preceding claims,
characterized in that
the correction element (KE1) is formed by at least one electrically conductive element.

19. Radio communication device according to claim 18,
characterized in that
one or more electrical wires, at least one single or multi-layer electrically conductive film, coating and/or other electrically conductive surface element are provided as the electrically conductive element.

20. Radio communication device according to one of claims 18 or 19,
characterized in that
the electrically conductive element (KE1) only extends continuously in the peripheral zone along the side edges of the housing (GH), while the other areas of the housing (GH) remain free.

21. Radio communication device according to one of claims 18 to 20,
characterized in that
the electrically conductive element (KE1) has a break (U1) at at least one point of its extension.

22. Radio communication device according to claim 21,
characterized in that
the electrically conductive element (KE1*) is omitted on one or two broad sides of the housing (GH).

23. Radio communication device according to one of claims 18 to 22,
characterized in that
the electrically conductive element (KE1) is in contact with the electric printed circuit board (LP) at only one contact point (COS1), while it is arranged along the remainder of its extension with a continuous gap clearance (QS) to the printed circuit board (LP).

24. Radio communication device according to one of claims 18 to 23,
characterized in that
the electrically conductive element (KE11) forms an edge running wholly or partially around the printed circuit board (LP), said edge being offset along the majority of its longitudinal extension with a transverse gap (QSP) to the printed circuit board (LP).

25. Radio communication device according to one of claims 18 to 24,
characterized in that
the width (SB) of the electrically conductive element (KE1) is selected as between 5% and 25% of the cross-sectional width (QB) of the printed circuit board (LP).

26. Radio communication device according to one of the preceding claims,
characterized in that
one or more magnetically and/or dielectrically active bodies (KE61, KE62) are provided as the additional correction element.

27. Radio communication device according to one of the preceding claims,
characterized in that
the additional correction element (KE9) comprises at least one discrete, electrical component (BE9).

28. Radio communication device according to one of the preceding claims,
characterized in that
the additional correction element (KE10) is configured so that is acts as a resonant antenna structure, with which partition currents (EC11*, EC12*) can be diverted in a targeted manner to the correction element.

29. Radio communication device according to one of the preceding claims,
characterized in that
the additional correction element (KE10) is connected via a matching network to the printed circuit board (LP).

30. Radio communication device according to one of the preceding claims,
characterized in that
the at least one current-conducting intermediate layer (ZL) is provided as the additional SAR value-reducing correction element in the form of a component of the keypad mat (TA) of the radio communication device (MP1).

31. Radio communication device according to claim 30,
characterized in that
the current-conducting intermediate layer (ZL) is configured so that it surrounds the printed circuit board (LP) in the form of a loop.

32. Radio communication device according to one of claims 30 or 31,
characterized in that
the current-conducting intermediate layer (ZL) has an earth contact (MK) to the earth layer (MP) of the printed circuit board (LP).

33. Radio communication device according to one of claims 30 to 32,
characterized in that
the current-conducting intermediate layer (ZL) is integrated between the support film (TF) and the key unit (TM) of the keypad mat (TA).

34. Printed circuit board (LP) with at least one additional SAR value-reducing correction element (KE1) according to one of the preceding claims.

35. Keypad mat (TA) with at least one current-conducting intermediate layer (ZL) to reduce the SAR value of a radio communication device according to one of claims 30 to 33.

36.
